(19) United States
(12) Patent Application Publication
(10) Pub. No.: US 2017/0331666 A1
(43) Pub. Date: Nov. 16, 2017

(54) REAL-TIME CONTROL INTERFACE FOR BROADCAST OBJECT STREAMING

(71) Applicant: QUALCOMM Incorporated, San Diego, CA (US)

(72) Inventors: Gordon Kent Walker, Poway, CA (US); Thomas Stockhammer, Bergen (DE)

(21) Appl. No.: 15/590,820

(22) Filed: May 9, 2017

Related U.S. Application Data
(60) Provisional application No. 62/334,948, filed on May 11, 2016.
(60) Provisional application No. 62/424,207, filed on Nov. 18, 2016.

(51) Int. Cl. H04L 29/06; H04N 21/426; H04N 21/262; H04N 21/234; H04N 21/6379

(52) U.S. Cl. CPC H04L 29/06476; H04N 21/6379; H04N 21/42676; H04L 29/06231; H04N 21/234; H04L 29/06455; H04N 21/26258

(57) ABSTRACT

A device for encoding and sending media data includes a scheduler unit that schedules transmission of media data, a media encoder, and a transmitter that transmits according to a schedule formed by the scheduler unit. The scheduler unit sends a first set of data to the media encoder representing a number of media segments of the media data to be broadcast and a time at which the media data must be available for delivery at the transmitter of the media broadcast device. The media encoder sends a second set of data representing a first number of estimated encoding bytes for the media data to the media encoder. The scheduler unit sends, to the transmitter, the number of media segments including respective portions of the encoded media data at or before the time at which the media data must be available for delivery at the transmitter.

This application claims the benefit of U.S. Provisional Application No. 62/334,948, filed May 11, 2016 and U.S. Provisional Application No. 62/424,207, filed Nov. 18, 2016, the entire contents of which are hereby incorporated by reference.

### TECHNICAL FIELD

This disclosure relates to broadcast of encoded media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), High Efficiency Video Coding (HEVC), also referred to as H.265 and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC. Video data may be transmitted via a computer-based network and/or over-the-air.

### SUMMARY

In general, this disclosure describes techniques related to real-time broadcast of multi-media data. In particular, these techniques include coordinating between a media encoder and a transmission scheduler, such that media data to be delivered is encoded with a particular capacity allocation (e.g., a size in bytes) by a time at which the media data is to be transmitted (e.g., broadcast). The techniques may be performed by a real-time control interface. This interface may manage a real-time media encoder, such as a video encoder with or without related encapsulation e.g., IP/UDP/ROUTE/ISO BMFF, and a physical layer capacity scheduler.

In one example, a method of sending media data includes, by a scheduler of a media broadcast device comprising a media encoder, the scheduler and the media encoder each implemented in circuitry: sending, to the media encoder, a first set of data representing a number of media segments of the media data to be broadcast and a time at which the media data must be available for delivery at a transmitter of the media broadcast device, receiving, from the media encoder, a second set of data representing a first number of estimated encoding bytes for the media data, and sending, to the transmitter, the number of media segments including an encoded version of the media data at or before the time at which the media data must be available for delivery at the transmitter.

In another example, a method of sending media data includes, by a media encoder of a media broadcast device comprising a scheduler, the media encoder and the scheduler each implemented in circuitry: receiving, from the scheduler, a first set of data representing a number of media segments of the media data to be broadcast and a time at which the media data must be available for delivery by the scheduler at a transmitter of the media broadcast device, determining a first number of estimated encoding bytes for the media data, sending a second set of data representing the first number of estimated encoding bytes for the media data to the scheduler, and sending a set of data including an encoded version of the media data to the scheduler.

In another example, a system for encoding and sending media data includes a scheduler unit that schedules transmission of media data, the scheduler unit implemented in circuitry, a media encoder that encodes media data, the media encoder implemented in circuitry, and a transmitter configured to transmit media data according to a schedule from the scheduler unit, the transmitter implemented in circuitry, where the scheduler unit is configured to send a first set of data to the media encoder representing a number of media segments of the media data to be broadcast and a time at which the media data must be available for delivery at the transmitter of the media broadcast device, the media encoder is configured to send a second set of data representing a first number of estimated encoding bytes for the media data to the media encoder, and the scheduler unit is configured to send, to the transmitter, the number of media segments including respective portions of the encoded media data at or before the time at which the media data must be available for delivery at the transmitter.

In another example, a device for encoding and sending media data includes a scheduler unit that schedules transmission of media data, the scheduler unit implemented in circuitry, a media encoder that encodes media data, the media encoder implemented in circuitry, and a transmitter configured to transmit media data according to a schedule from the scheduler unit, the transmitter implemented in circuitry, where the scheduler unit is configured to send a first set of data to the media encoder representing a number of media segments of the media data to be broadcast and a time at which the media data must be available for delivery at the transmitter of the media broadcast device, the media encoder is configured to send a second set of data representing a first number of estimated encoding bytes for the media data to the media encoder, and the scheduler unit is configured to send, to the transmitter, the number of media segments including respective portions of the encoded media data at or before the time at which the media data must be available for delivery at the transmitter.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of a reception unit.

FIG. 3 is a conceptual diagram illustrating elements of example multimedia content.

FIG. 4 is a block diagram illustrating elements of an example video file, which may correspond to a segment of a representation.

FIG. 5 is a block diagram illustrating an example broadcast infrastructure system.

FIG. 6 is a block diagram illustrating the scope of a real-time control interface of a broadcast infrastructure system.

FIG. 7 is a flow diagram illustrating an example call flow for allocation negotiation between a media encoder and a scheduler.

### DETAILED DESCRIPTION

In general, this disclosure describes techniques related to real-time broadcast of media data. In particular, these techniques include coordinating between a media encoder and a transmission scheduler unit, such that media data to be delivered is encoded with a particular capacity allocation (e.g., a size in bytes) by a time at which the media data is to be transmitted (e.g., broadcast). The techniques may be performed by a real-time control interface. This interface may manage a real-time media encoder, such as a video encoder or an audio encoder with their related encapsulation(s), and a physical layer capacity scheduler.

The techniques of this disclosure may be applied to video conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats. Such video files may be assembled into, e.g., Dynamic Adaptive Streaming over HTTP (DASH) Segments, which form parts of one or more DASH Representations, as explained below. Ultimately, the Segments may be transmitted using a computer-based network, e.g., according to a unicast, broadcast, or multicast network protocol, or broadcast over-the-air (OTA), e.g., according to Advanced Television Systems (ATSC) 3.0.

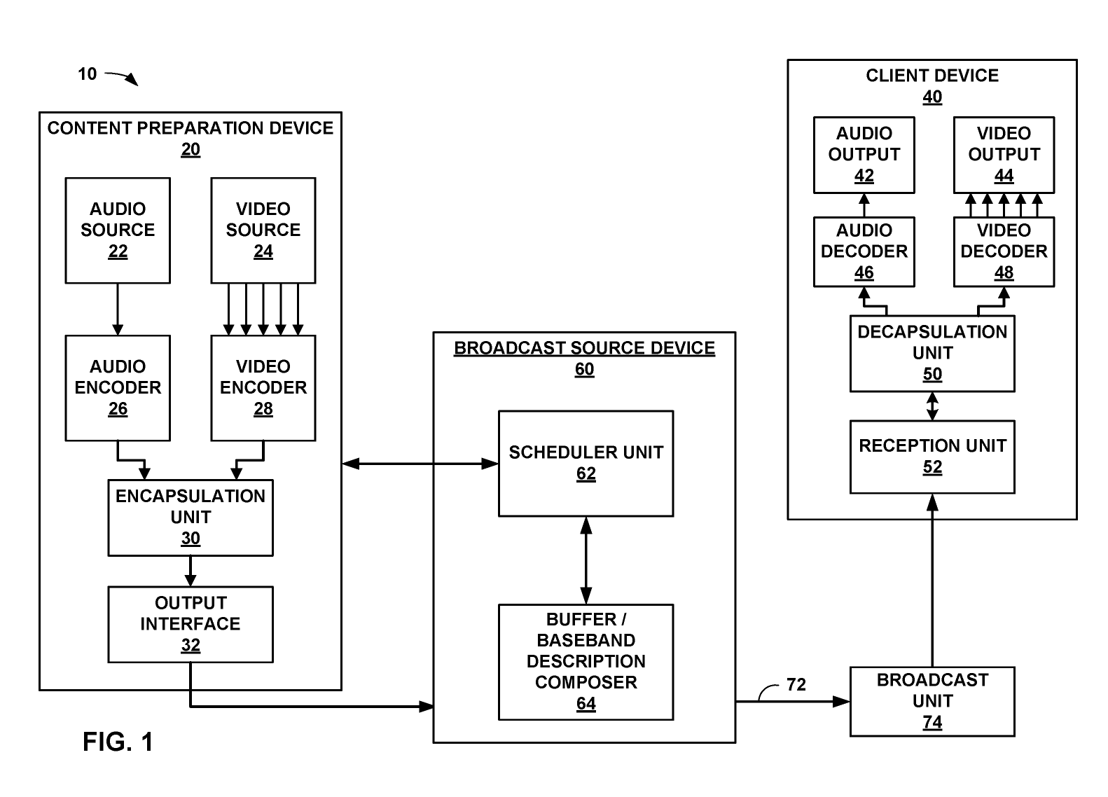

FIG. 1 is a block diagram illustrating an example system 10 that implements techniques for streaming media data via an over-the-air (OTA) broadcast. In this example, system 10 includes content preparation device 20, broadcast source device 60, broadcast unit 74, and client device 40. Broadcast source device 60 may comprise, for example, a portion of a television studio, a cable television headend, or satellite uplink. Alternatively, content preparation device 20 including a media encoder may supply multimedia content to encapsulation unit 30 via delivery of a computer-readable storage medium, such as a hard disk, a flash drive, a CD, a DVD, a Blu-ray disc, or the like. In some examples, content preparation device 20 may be comprised of a single unit or several individual units e.g., 26, 28, 30, 32. and broadcast source device 60 may comprise the same device.

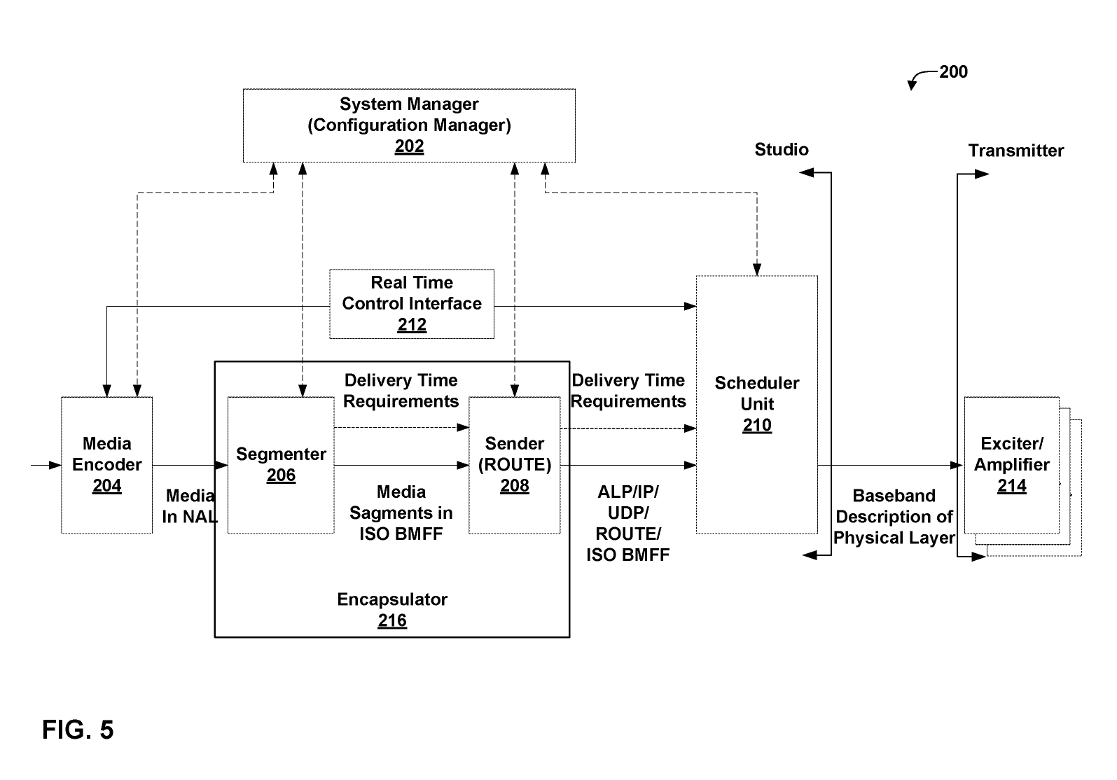

In general, content preparation device 20 and/or broadcast source device 60 may perform the techniques of this disclosure. Such techniques are described in greater detail with respect to FIGS. 5-7. Thus, aspects discussed with respect to FIGS. 5-7 may be incorporated into system 10 of FIG. 1, and in particular, into either or both of content preparation device 20 and/or broadcast source device 60 (or a device that performs the functionality attributed to both content preparation device 20 and broadcast source device 60).

Content preparation device 20, in the example of FIG. 1, includes audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to broadcast source device 60 in all examples, but may store multimedia content to a separate medium that is read by broadcast source device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time (or are otherwise to be presented at the same time) and for which an audio frame and a video frame comprise, respectively, the audio data and the video data that was captured at the same time. In addition, audio data may be generated separately that is to be presented contemporaneously with the video and other audio data, e.g., narration.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces encoded audio data, while video encoder 28 produces encoded video data. In some examples, e.g., in accordance with Real-Time Object Delivery over Unidirectional Transport (ROUTE) protocol, media objects may be streamed in a manner similar in function to an elementary stream. This also bears a resemblance to progressive download and playback. A ROUTE session may include one or more Layered Coding Transport (LCT) sessions. LCT is described in Luby et al., “Layered Coding Transport (LCT) Building Block,” RFC 5651, October 2009.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. Similarly, audio encoder 26 may encode audio data in a variety of different ways with various characteristics. As discussed in greater detail below, for example, audio encoder 26 may form audio adaptation sets that each include one or more of scene-based audio data, channel-based audio data, and/or object-based audio data. In addition or in the alternative, audio encoder 26 may form adaptation sets that include scalable audio data. For example, audio encoder 26 may form adaptation sets for a base layer, left/right information, and height information, as discussed in greater detail below.

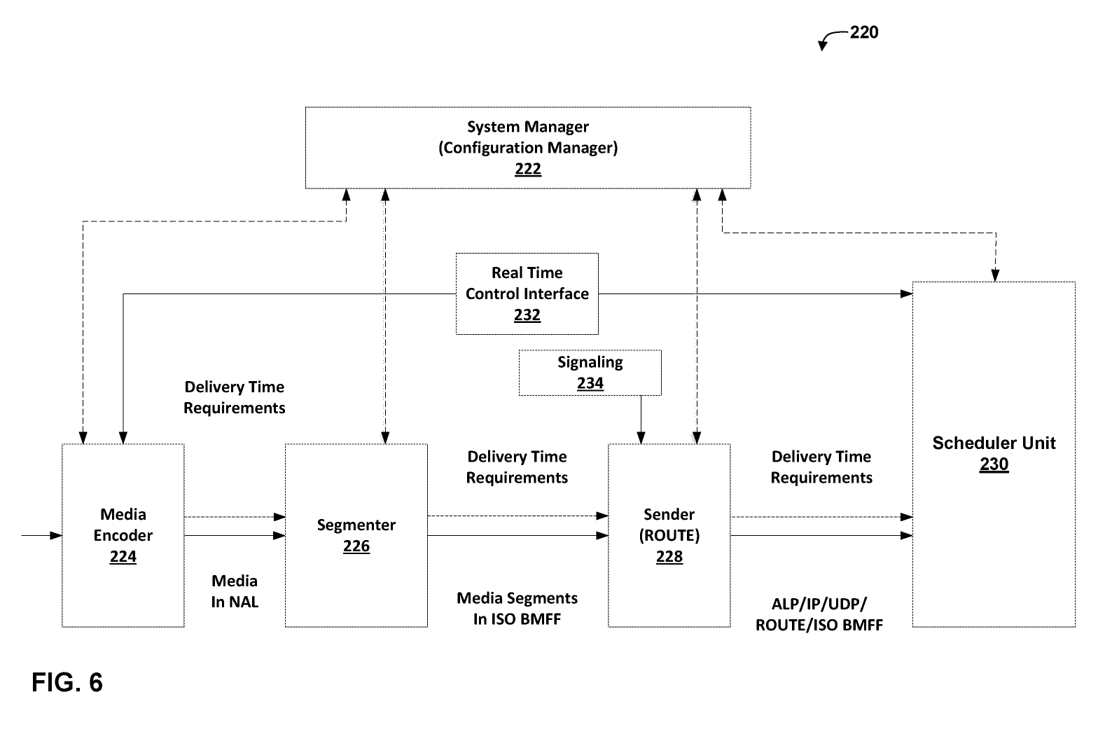

Encapsulation unit 30 receives media from audio encoder 26 and video encoder 28 and forms corresponding network abstraction layer (NAL) units for delivery to a Segmenter, as discussed in greater detail below with respect to FIGS. 5 and 6. Alternatively, encapsulation unit 30 may itself include the Segmenter. In general, the Segmenter forms Segments, which may generally correspond to deliverable files, each file including a plurality of media samples.

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to broadcast source device 60 via network transmission or storage media. In the example of FIG. 1, broadcast source device 60 includes scheduler unit 62 and buffer/baseband description composer 64. In some examples, output interface 32 may also send data directly to broadcast unit 74.

In some examples, representations may be separated into adaptation sets. That is, various subsets of representations may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

A manifest file may include data indicative of the subsets of representations corresponding to particular adaptation sets, as well as common characteristics for the adaptation sets. Manifest file may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of a manifest file.

Broadcast source device 60 includes buffer/baseband description composer 64 and output interface 72. Broadcast source device 60 provides multimedia content to broadcast unit 74 via buffer/baseband description composer 64 and output interface 72.

Multimedia content may include a manifest file, which may correspond to a media presentation description (MPD). The manifest file may contain descriptions of different alternative representations (e.g., video services with different qualities) and the description may include, e.g., codec information, a profile value, a level value, a bitrate, and other descriptive characteristics of representations. Client device 40 may retrieve the MPD of a media presentation to determine how to access segments of the representations.

In particular, reception unit 52 may include both an OTA broadcast middleware unit and a media player client. The OTA broadcast middleware unit may act as a proxy server for the media player client, which may be configured to retrieve media data via network protocols, e.g., in accordance with Dynamic Adaptive Streaming over HTTP (DASH). That is, the media client may comprise a DASH client. Thus, the media client may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. The media client may be configured to submit HTTP GET and partial GET requests to the OTA broadcast middleware unit. Certain aspects of reception unit 52 may be implemented as software instructions executed by one or more processors or processing units (not shown) of client device 40. That is, portions of the functionality described with respect to reception unit 52 may be implemented in hardware, or a combination of hardware, software, and/or firmware, where requisite hardware may be provided to execute instructions for software or firmware.

The media player client of reception unit 52 may compare the decoding and rendering capabilities of client device 40 to characteristics of representations indicated by information of a manifest file. The media player client may initially retrieve at least a portion of a manifest file to determine characteristics of representations. For example, the media player client may request a portion of a manifest file that describes characteristics of one or more adaptation sets. The media player client may select a subset of representations (e.g., an adaptation set) having characteristics that can be satisfied by the coding and rendering capabilities of client device 40. The media player client may then determine bitrates for representations in the adaptation set, determine a currently available amount of network bandwidth, and retrieve segments from one of the representations having a bitrate that can be satisfied by the network bandwidth.

As noted above, reception unit 52 may include an OTA broadcast middleware unit. The OTA broadcast middleware unit may be configured to receive OTA broadcast signals, e.g., in accordance with ATSC. Furthermore, the OTA broadcast middleware unit may implement a network proxy server that caches received media data locally and responds to network requests for data from a media player client of reception unit 52.

Although this example includes OTA broadcasts in accordance with, e.g., ATSC, in other examples, media data may be transported via network broadcasts, such as Enhanced Multimedia Broadcast Multicast Service (eMBMS). In such examples, media data may be broadcast or multicast by a network server (which may generally correspond to broadcast source device 60) to client device 40 via a computer-based network (not shown in this example). The network may be positioned between the server device and client device 40, and may include various network devices, such as routers, switches, hubs, gateways, and the like. Furthermore, reception unit 52 may include an eMBMS middleware unit, in place of an OTA broadcast middleware unit. The eMBMS middleware unit may operate substantially the same as the OTA broadcast middleware unit described in this example, except for the inclusion of an eMBMS reception unit in place of the OTA broadcast reception unit as described herein.

Reception unit 52 provides received segments to decapsulation unit 50. Decapsulation unit 50 may decapsulate elements of a video file into constituent media objects, decapsulate the media objects to retrieve encoded data, and send the encoded data to either audio decoder 46 or video decoder 48, depending on whether the encoded data is part of an audio or video media object, e.g., as indicated by media object headers. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, reception unit 52, and decapsulation unit 50 each may be implemented as any of a variety of suitable fixed function and/or programmable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, reception unit 52, and/or decapsulation unit 50 may comprise an integrated circuit, a microprocessor, and/or a wireless communication device, such as a cellular telephone.

Client device 40, broadcast source device 60, and/or content preparation device 20 may be configured to operate in accordance with the techniques of this disclosure. For purposes of example, this disclosure describes these techniques with respect to client device 40 and broadcast source device 60. However, it should be understood that content preparation device 20 may be configured to perform these techniques, instead of (or in addition to) broadcast source device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28. Encapsulation unit 30 may assemble the encoded video and audio data into constituent media objects for delivery.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as a manifest file. Client device 40 may retrieve the MPD of a media presentation to determine how to access movie fragments of various presentations. Movie fragments may be located in movie fragment boxes (moof boxes) of video files.

A manifest file (which may comprise, for example, an MPD) may advertise availability of segments of representations. That is, the MPD may include information indicating the wall-clock time at which a first segment of one of representations becomes available, as well as information indicating the durations of segments within representations. In this manner, reception unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Reception unit 52 extracts NAL units or access units from broadcast signals received from broadcast unit 74 and provides the NAL units or access units to reception unit 52, which may deliver the NAL units to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Although not shown explicitly in the example of FIG. 1, client device 40 may further include a media application. The media application may perform all or a portion of the functionality of any of audio decoder 46, video decoder 48, decapsulation unit 50, and/or reception unit 52. For example, the media application may form part of reception unit 52, or be separate from reception unit 52. In addition to the functionality described above, the media application may cause client device 40 to present a user interface, such as a graphical user interface (GUI) to a user to allow for selection of multimedia data, such as a movie or other program content. The media application may provide an indication of the selected content to reception unit 52 to cause reception unit 52 to receive media data of the selected program content, as discussed above. The media application may be stand-alone software.

Content preparation device 20 and broadcast source device 60 represent an example of a system for encoding and sending media data including a scheduler unit that schedules transmission of media data, the scheduler unit implemented in circuitry, a media encoder that encodes media data, the media encoder implemented in circuitry, and a transmitter configured to transmit media data according to a schedule from the scheduler unit, the transmitter implemented in circuitry, where the scheduler unit is configured to send a first set of data to the media encoder representing a number of media segments of the media data to be broadcast and a time at which the media data must be available for delivery at the transmitter of the media broadcast device, the media encoder is configured to send a second set of data representing a first number of estimated encoding bytes for the media data to the media encoder, and the scheduler unit is configured to send, to the transmitter, the number of media segments including respective portions of the encoded media data at or before the time at which the media data must be available for delivery at the transmitter.

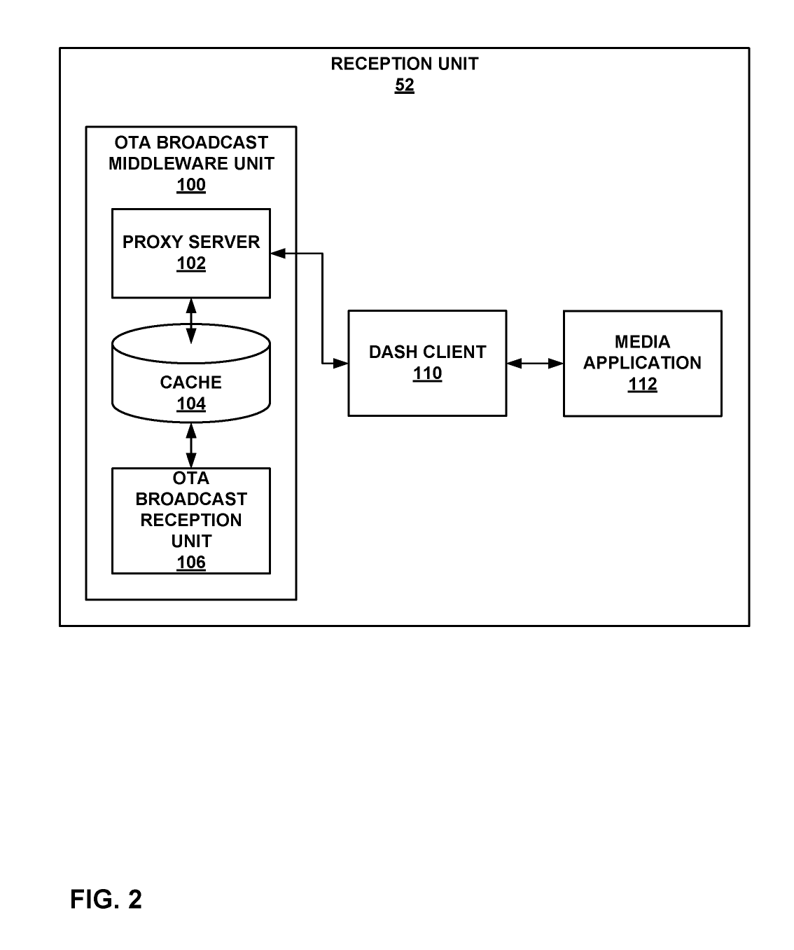

FIG. 2 is a block diagram illustrating an example set of components of reception unit 52 of FIG. 1 in greater detail. In this example, reception unit 52 includes OTA broadcast middleware unit 100, DASH client 110, and media application 112.

OTA broadcast middleware unit 100 further includes OTA broadcast reception unit 106, cache 104, and proxy server 102. In this example, OTA broadcast reception unit 106 is configured to receive data via an OTA broadcast, e.g., via an Advanced Television Systems Committee (ATSC) broadcast. That is, OTA broadcast reception unit 106 may receive files via broadcast from, e.g., broadcast source device 60.

As OTA broadcast middleware unit 100 receives data for files, OTA broadcast middleware unit 100 may store the received data in cache 104. Cache 104 may comprise a computer-readable storage medium, such as flash memory, a hard disk, RAM, or any other suitable storage medium.

Proxy server 102 may act as a proxy server for DASH client 110. For example, proxy server 102 may provide a MPD file or other manifest file to DASH client 110. Proxy server 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server 102. Proxy server 102 may retrieve requested data from cache 104 and provide the data to DASH client 110 in response to such requests.

After receiving a segment, DASH client 110 may pass data of the segment to media application 112. DASH client 110 may process the segment, e.g., to extract media data from the segment and/or to discard data that is unusable by media application 112. In some examples, DASH client 110 may be implemented as an extension to a web browser, and media application 112 may be implemented as a video and/or music playing application.

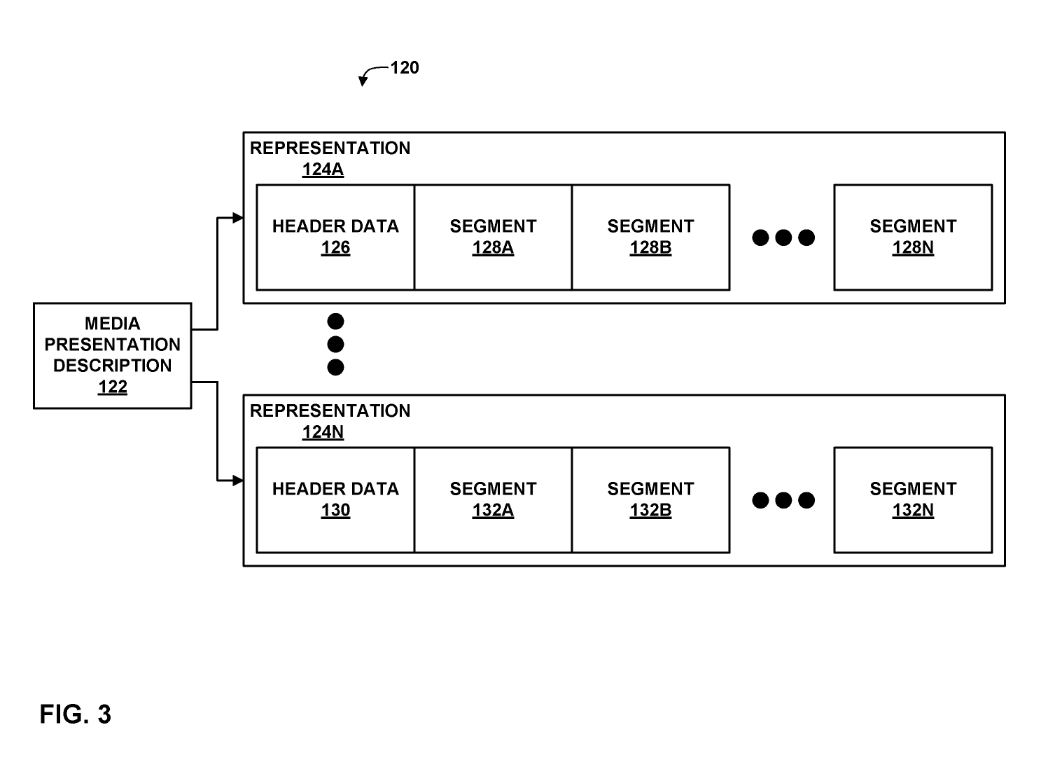

FIG. 3 is a conceptual diagram illustrating elements of example multimedia content 120. Multimedia content 120 may correspond to multimedia content processed by system 10 of FIG. 1. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to a manifest file as discussed with respect to FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

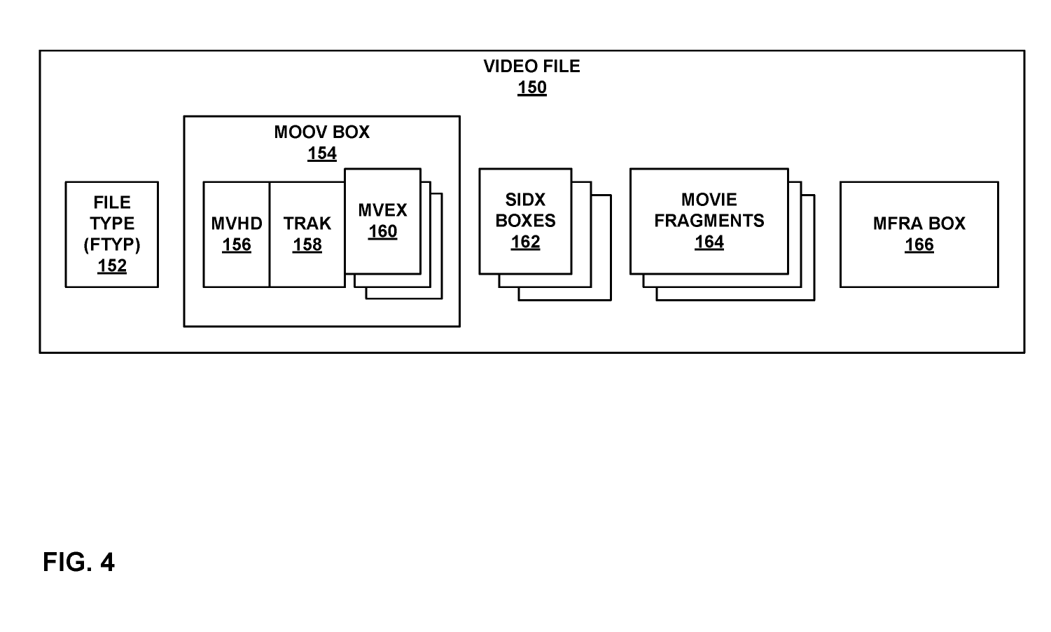

FIG. 4 is a block diagram illustrating elements of an example video file 150, which may correspond to a segment of a representation, such as one of segments 114, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

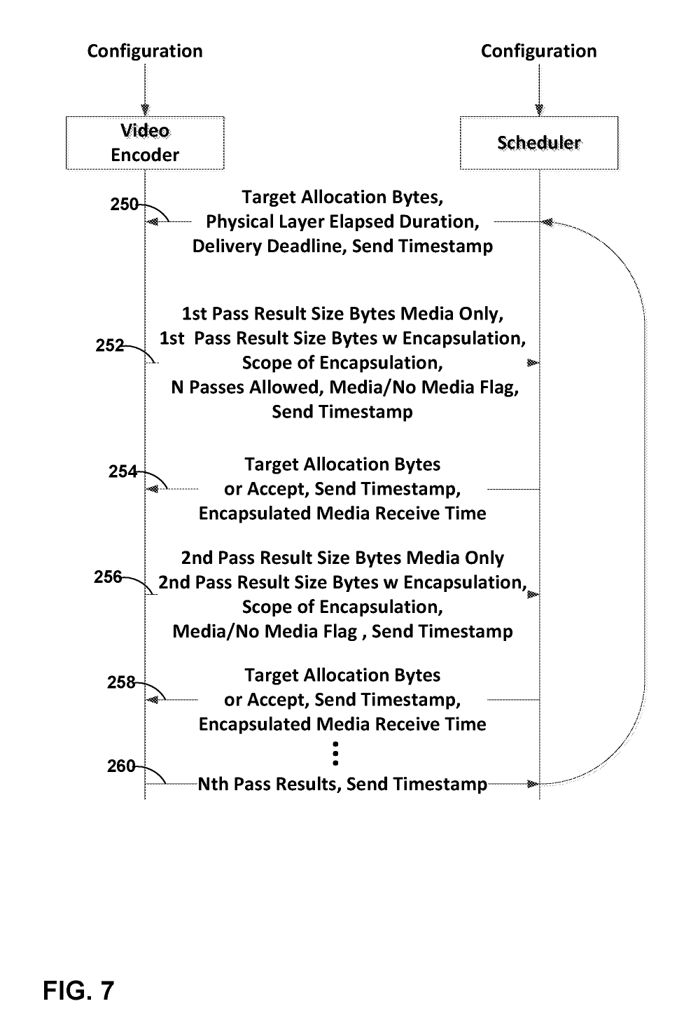

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150. FIG. 7, discussed in greater detail below, provides additional information with respect to the MPD update box.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 3) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units which contains the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

FIG. 5 is a block diagram illustrating an example broadcast infrastructure system 200. In this example, broadcast infrastructure system 200 includes system manager 202 (also referred to as a configuration manager), media encoder 204, encapsulator 216 (which includes segmenter 206 and sender 208 (which may implement ROUTE)), scheduler unit 210, real-time control interface 212, and exciter/amplifier 214. Broadcast infrastructure system 200 may be included as part of system 10 of FIG. 1. For example, media encoder 204 may correspond to audio encoder 26 and/or video encoder 28, segmenter 206 may correspond to encapsulation unit 30, and the other elements may be included within output interface 32 (or scheduler unit 62 and/or buffer/baseband description composer 64 of broadcast source device 60).

Broadcast infrastructure system 200 represents an example of a streaming object-based broadcast system, such as for ATSC 3.0. Scheduler unit 210 represents an example of a scheduler that maps streaming media objects and other file-based data onto a physical layer for transmission (e.g., by exciter/amplifier 214).

The span of broadcast infrastructure system 200 is such that a single vendor typically does not or may not offer both encoders (e.g., media encoder 204) and the physical layer scheduler (e.g., scheduler unit 210). Hence, the techniques of this disclosure may be used to fulfill a need for a common shared interface for real-time control. Further it is important that the interface operate without either entity, e.g., scheduler unit 210 or media encoder 204, being configured according to the internal design of the other. This is not to say that the configuration of the entities on their respective quasi-static or static interfaces is not known to the other entity. It may be essential that certain aspects are. However, the real-time control interface does not contain proprietary internal design information about the respective entities. The real-time control interface may enable collaboration among the entities for the purpose of scheduling streaming object media on the physical layer.

Real-time control interface 212 represents an example of an interface between media encoder 204 and scheduler unit 210 that may perform certain or all techniques of this disclosure, alone or in any combination. In general, real-time control interface 212 may operate to allow the following to be accomplished:
Allow scheduler unit 210 to negotiate a media size among scheduler unit 210 and the related media encoders (including media encoder 204) so as to provide services in a continuous manner i.e., linear service.
Allow a streaming media encoder (such as media encoder 204) to find a solution for said streaming objects in faster than real-time.
Allowing resulting streaming media to transit from the media encoder(s) to the scheduler unit 210 stack inside the encapsulation process, as shown in FIG. 6 below.
Allow, based on the design of the real-time control interface, advanced media encoding techniques, but not require them. Such advanced media encoding techniques may include, for example, the ability to provide an estimated data size without executing a complete encode.
Allow (and potentially require) media encoders to provide complete media data along with related delivery metadata, even if the result is not an accepted solution.
Allow and enable the scheduler to determine the layers/level of encapsulation present in the delivered media and the encapsulated size provided in the real time control interface

With respect to determination of the layers/level of encapsulation, the scheduler may receive (and the media encoder may provide) data that signals which layers of encapsulation are present in the reported size. Such layers may include one or more of ISO BMFF, ROUTE, user datagram protocol (UDP), Internet protocol (IP), and/or ATSC 3.0 Link-layer Protocol (ALP). ROUTE could be replaced with MPEG Media Transport (MMT) in this list.

The finite duration of a media encoding pass requires that a limited number of encoding passes are allowed (that is, for real-time encoding and broadcast of media data). The actual number of encode passes is defined/constrained by the constituent equipment and is not limited by the real-time control interface. The static or quasi static control settings of the entities should be set such that the physical layer allocation negotiation can converge.

In this manner, system 200 of FIG. 5 represents an example of a system for encoding and sending media data including a scheduler unit that schedules transmission of media data, the scheduler unit implemented in circuitry, a media encoder that encodes media data, the media encoder implemented in circuitry, and a transmitter configured to transmit media data according to a schedule from the scheduler unit, the transmitter implemented in circuitry, where the scheduler unit is configured to send a first set of data to the media encoder representing a number of media segments of the media data to be broadcast and a time at which the media data must be available for delivery at the transmitter of the media broadcast device, the media encoder is configured to send a second set of data representing a first number of estimated encoding bytes for the media data to the media encoder, and the scheduler unit is configured to send, to the transmitter, the number of media segments including respective portions of the encoded media data at or before the time at which the media data must be available for delivery at the transmitter.

FIG. 6 is a block diagram illustrating the scope of a media encoder real-time control interface 232 of broadcast infrastructure system 220 in accordance with the techniques of this disclosure. In general, the elements of broadcast infrastructure system 220 may correspond substantially to the similarly-named elements of broadcast infrastructure system 200 of FIG. 5. However, the example of FIG. 6 illustrates an alternate termination point for the media encoder real-time control interface. These two configurations represent two possibilities. The actual scope of encapsulation is described in the real time control interface, such that the scheduler always is aware.

In this manner, system 220 of FIG. 6 represents an example of a system for encoding and sending media data including a scheduler unit that schedules transmission of media data, the scheduler unit implemented in circuitry, a media encoder that encodes media data, the media encoder implemented in circuitry, and a transmitter configured to transmit media data according to a schedule from the scheduler unit, the transmitter implemented in circuitry, where the scheduler unit is configured to send a first set of data to the media encoder representing a number of media segments of the media data to be broadcast and a time at which the media data must be available for delivery at the transmitter of the media broadcast device, the media encoder is configured to send a second set of data representing a first number of estimated encoding bytes for the media data to the media encoder, and the scheduler unit is configured to send, to the transmitter, the number of media segments including respective portions of the encoded media data at or before the time at which the media data must be available for delivery at the transmitter.

It should be understood that the various components of the systems of FIGS. 5 and 6 may be included in a single device or a plurality of devices, e.g., as shown in FIG. 1. Thus, the systems of FIGS. 5 and 6 also represent examples of a device for encoding and sending media data including a scheduler unit that schedules transmission of media data, the scheduler unit implemented in circuitry, a media encoder that encodes media data, the media encoder implemented in circuitry, and a transmitter configured to transmit media data according to a schedule from the scheduler unit, the transmitter implemented in circuitry, where the scheduler unit is configured to send a first set of data to the media encoder representing a number of media segments of the media data to be broadcast and a time at which the media data must be available for delivery at the transmitter of the media broadcast device, the media encoder is configured to send a second set of data representing a first number of estimated encoding bytes for the media data to the media encoder, and the scheduler unit is configured to send, to the transmitter, the number of media segments including respective portions of the encoded media data at or before the time at which the media data must be available for delivery at the transmitter.

FIG. 7 is a flow diagram illustrating an example call flow for allocation negotiation between, e.g., media encoder 204 and scheduler unit 210 of FIG. 5 (or media encoder 224 and scheduler unit 230 of FIG. 6). The method of FIG. 5 is based on a bidirectional real-time connection among the scheduler and the various media encoders (with associated encapsulation). Scheduler unit 210 initiates a negotiation session by delivery of negotiation session information, which includes the elapsed duration at the physical layer that the delivered media segment(s) represent. There is no requirement that scheduler unit 210 conform the allocation to a single frame at the physical layer. The delivery deadline is provided for the benefit of media encoder 204, so that media encoder 204 has data indicating when the encoding must be finished. It is assumed that all entities (e.g., of FIGS. 5 and 6, such as media encoder 204 and scheduler unit 210) have access to accurate time.

The delivery deadline is the latest time for the media encoder to deliver the Nth pass results to a transmitter. Media encoders may send a real-time control response upon delivery of encoded media on the outbound interface of the media encoder, unless the media encoder signals that no media was sent. The termination point of the real-time control interface can be after encapsulation or before, as shown above in FIG. 6. The scheduler unit may determine the termination point via data received from the real-time control interfaces.

In the example method of FIG. 7, the scheduler unit initially sends the media encoder a set of data representing target allocation bytes, a physical layer elapsed duration, delivery deadline, and a send timestamp (250). Thus, this set of data includes at least data representing a number of media segments (e.g., individually retrievable/deliverable files) of media data to be broadcast, and a time at which the media data must be available for delivery at a transmitter unit (e.g., exciter/amplifier 214 of FIG. 5).

In response, the media encoder delivers, in this example, first pass estimated or resulting byte size for encoded media, first pass estimated or resulting byte size for encapsulated media data (i.e., the encoded media plus one or more layers of encapsulation data, e.g., for ISO BMFF, ROUTE, FLUTE, UDP, IP, ALP, or the like), a scope of the encapsulation (e.g., which encapsulation layers are used), a number of encoding passes allowed, a media/no media flag indicating whether encoded media data is being provided, and a send timestamp (252). The number of encoding bytes may be based on the results of an initial encoding pass, and may or may not be accompanied by encoded media data resulting from this pass (as indicated by the media/no media flag). In this manner, this set of data includes at least data representing a first number of estimated encoding bytes for the media data. The estimated encoding bytes may represent an estimate of the number of encoding bytes to be delivered, which may be based on an actual encoding pass. However, the number of encoding bytes used to encode the media data may be reduced after multiple encoding passes.

The scheduler unit may then send data to the media encoder representing a new target allocation of bytes (or an indication that the encoded media data of the previous pass has been accepted), a send timestamp, and an encapsulated media receive time (254). Assuming the media data as received from the media encoder is not accepted, the target allocation of bytes may represent a target number of bytes to be used to encode the media data (which may be smaller than the target allocation described with respect to step 250 above).

In response to the target allocation of bytes, the media encoder may send second encoding pass resulting byte size for encoded media data (alone and/or encapsulated), a scope of the encapsulation (if any), a media/no media flag as discussed above, and a send timestamp (256). The number of encoding bytes may be based on the results of another encoding pass, and may or may not be accompanied by encoded media data resulting from this pass (as indicated by the media/no media flag).

Again, the scheduler unit may provide a new target allocation of bytes or accept the encoded media data, a send timestamp, and an encapsulated media receive time to the media encoder (258). This may prompt a third encoding pass by the media encoder. Similar steps may be performed by the scheduler unit and the media encoder (260), to attempt to compress the media data as much as possible, up to the time at which the encoded media data must be available at the transmitter unit.

In accordance with the example method of FIG. 7, scheduler unit 210 may send the parameters shown in Table 1 below to media encoder 204 (or scheduler unit 230 and media encoder 224 of FIG. 6):

TABLE 1
Scheduler Sent Parameters

| Scheduler | | |
|---|---|---|
| Parameter | Purpose | Comments |
| Target Media | Define target size for | Required function, but first instance of the |
| Allocation in | encoder | parameter in a negotiation can be optional. |
| Bytes | | Encoder may be able to get closer to |
| | | correct settings if it has a first target size. |
| Elapsed Duration | Define time duration | Must represent an integer number Media |
| at the Physical Layer | that media represents | Segments including required IDRs at the |
| | | average IDR rate. Must include integer |
| | | number of IDRs and the related Media |
| | | Segments |
| Delivery Deadline | Advise encoder when | Helps in estimation of N for the encoder |
| | the negotiation must | and is required for real-time operation. |
| | be completed | |
| Send Timestamp | Allow latency | |
| | detection | |
| Accept | The Scheduler | Causes media encoder to prepare for the |
| | acknowledges that | next negotiation cycle. |
| | delivered result was | |
| | acceptable | |
| Encapsulated | Allows media | Real-time control interface sends on |
| Media Receive | encoder to determine | completion of media delivery for last |
| Time | elapsed time in | completed media deliver pass, unless no |
| | encapsulation process | media was sent and No Media was |
| | | signaled. |

In accordance with the example method of FIG. 7, media encoder 28 may send the parameters shown in Table 2 below to scheduler unit 210:

TABLE 2
Media Encoder Sent Parameters

| Media Encoder | | |
|---|---|---|
| Parameter | Purpose | Comments |
| TBD Pass Result | Reports current | Value may be estimated or describe an |
| | required media | actual encode process |
| | encoder allocation | |
| | size | |
| TBD Pass Result | Reports current | Optional parameter, populated only if the |
| w/ Encapsulation | allocation size with | encoder knows or can estimate |
| | all required | encapsulation size, i.e., the encoder |
| | encapsulation | includes the encapsulation function(s) |
| Scope of | Describes the levels/ | These for example might be |
| Encapsulation | layers of | ALP/IP/UDP/ROUTE/ISO BMFF |
| | encapsulation present | |
| Delivery Deadline | Advise media | Helps in estimation of N by the encoder. |
| | encoder when the | |
| | negotiation must be | |
| | completed | |
| Media/No Media Flag | Allows encoder to | Media is sent if encode was completed. |
| | signal whether | Recommended practice may require a |
| | encoded media was | complete encode except on first pass |
| | sent | estimate |
| Send Timestamp | Identify when | Allow for latency estimation. Made be |
| | message was sent | used for encapsulation delay |
| | | measurement, if the media delivery |
| | | interface is synchronized to real-time |
| | | control interface |

In this manner, the method of FIG. 7 represents an example of a method of sending media data, the method including, by a scheduler of a media broadcast device comprising a media encoder, the scheduler and the media encoder each implemented in circuitry: sending, to the media encoder, a first set of data representing a number of media segments of the media data to be broadcast and a time at which the media data must be available for delivery at a transmitter of the media broadcast device, receiving, from the media encoder, a second set of data representing a first number of estimated encoding bytes for the media data, and sending, to the transmitter, the number of media segments including an encoded version of the media data at or before the time at which the media data must be available for delivery at the transmitter.

The method of FIG. 7 also represents an example of a method of sending media data, the method including, by a media encoder of a media broadcast device comprising a scheduler, the media encoder and the scheduler each implemented in circuitry: receiving, from the scheduler, a first set of data representing a number of media segments of the media data to be broadcast and a time at which the media data must be available for delivery by the scheduler at a transmitter of the media broadcast device, determining a first number of estimated encoding bytes for the media data, sending a second set of data representing the first number of estimated encoding bytes for the media data to the scheduler, and sending a set of data including an encoded version of the media data to the scheduler.

The techniques of this disclosure as described above generally include techniques for enabling rapid estimate of required media allocation size, without full encode at the media encoder, for a media encoder to signal whether media was delivered in addition to the real-time control interface response, for a media encoder to signal the number of passes it is going to execute based on its own capability and media complexity (the encapsulation time may be included in the signaled number of encoding passes), for a scheduler unit to express capacity allocation to a media encoder requiring no understanding of physical layer configuration by the media encoder, for a scheduler unit to express a desired media runtime to a media encoder independent of physical layer configuration, and for alternate configuration of encapsulation and media encoder real-time interface. For example, the media encoder may only report known results (that is, the media encoder may avoid providing encapsulation results if no encapsulation is known by the controlled encoder), and the media encoder may provide a description of encapsulation present in the encapsulated size.

Thus, the techniques of this disclosure include, among other things, a real-time control interface for object based media streaming based on a broadcast physical layer. The actual configuration of the broadcast physical layer may be opaque to the media encoder(s).

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of sending media data, the method comprising:
by a scheduler of a media broadcast device comprising a media encoder, the scheduler and the media encoder each implemented in circuitry:
sending, to the media encoder, a first set of data representing a number of media segments of the media data to be broadcast and a time at which the media data must be available for delivery at a transmitter of the media broadcast device;
receiving, from the media encoder, a second set of data representing a first number of estimated encoding bytes for the media data; and
sending, to the transmitter, the number of media segments including an encoded version of the media data at or before the time at which the media data must be available for delivery at the transmitter.

2. The method of claim 1, further comprising:
sending a third set of data representing a target byte allocation for the media data to the media encoder in response to the first number of estimated encoding bytes; and
receiving, from the media encoder, a fourth set of data including the number of media segments including the media data encoded by the media encoder.

3. The method of claim 2, wherein the second set of data includes a first encoded version of the media data encoded by the media encoder, and wherein the fourth set of data includes a second, different encoded version of the media data encoded by the media encoder.

4. The method of claim 1, wherein sending the first set of data further comprises sending a target byte allocation for the media data to the media encoder.

5. The method of claim 1, further comprising determining whether the media encoder includes one or more encapsulation units based on data received from the media encoder.

6. The method of claim 1, further comprising sending data indicating that the media data encoded by the media encoder has been accepted to the media encoder.

7. The method of claim 1, wherein the second set of data includes an encoded version of the media data.

8. The method of claim 1, further comprising receiving, from the media encoder, data representing one or more layers of encapsulation in which the media data has been encapsulated.

9. The method of claim 8, wherein the layers of encapsulation include one or more of ISO base media file format (BMFF) data, Real-Time Object Delivery over Unidirectional Transport (ROUTE) data, MPEG Media Transport (MMT) data, user datagram protocol (UDP), Internet protocol (IP), or ATSC 3.0 Link-layer Protocol (ALP).

10. A method of sending media data, the method comprising:
by a media encoder of a media broadcast device comprising a scheduler, the media encoder and the scheduler each implemented in circuitry:
receiving, from the scheduler, a first set of data representing a number of media segments of the media data to be broadcast and a time at which the media data must be available for delivery by the scheduler at a transmitter of the media broadcast device;
determining a first number of estimated encoding bytes for the media data;
sending a second set of data representing the first number of estimated encoding bytes for the media data to the scheduler; and
sending a set of data including an encoded version of the media data to the scheduler.

11. The method of claim 10, further comprising:
receiving, from the scheduler, a third set of data representing a second target byte allocation for the media data; and
encoding the media data such that the encoded version of the media data has a number of encoded bytes that is less than or equal to the second target byte allocation.

12. The method of claim 11, further comprising sending a fourth set of data comprising the encoded version of the media data to the scheduler.

13. The method of claim 10, wherein the first set of data further includes a target byte allocation for the media data.

14. The method of claim 10, further comprising sending the encoded media data to a segmenter that forms the number of segments including the media data.

15. The method of claim 10, further comprising sending data representing a number of instantaneous decoder refresh (IDR) pictures corresponding to a playback time for the number of segments to the scheduler.

16. The method of claim 10, further comprising sending data representing whether an encoded version of the media data accompanies the estimated encoding bytes to the scheduler.

17. The method of claim 10, wherein determining the first number of estimated encoding bytes comprises encoding the media data during a first encoding pass.

18. The method of claim 10, further comprising sending data representing a number of encoding passes to achieve a target byte allocation to the scheduler.

19. A system for encoding and sending media data, the system comprising:
a scheduler unit that schedules transmission of media data, the scheduler unit implemented in circuitry;
a media encoder that encodes media data, the media encoder implemented in circuitry; and
a transmitter configured to transmit media data according to a schedule from the scheduler unit, the transmitter implemented in circuitry,
wherein the scheduler unit is configured to send a first set of data to the media encoder representing a number of media segments of the media data to be broadcast and a time at which the media data must be available for delivery at the transmitter of the media broadcast device;
wherein the media encoder is configured to send a second set of data representing a first number of estimated encoding bytes for the media data to the media encoder; and
wherein the scheduler unit is configured to send, to the transmitter, the number of media segments including respective portions of the encoded media data at or before the time at which the media data must be available for delivery at the transmitter.

20. The system of claim 19,
wherein the scheduler unit is further configured to send a third set of data representing a target byte allocation for the media data to the media encoder in response to the first number of estimated encoding bytes;
wherein the media encoder is further configured to encode the media data such that the encoded version of the media data has a number of encoded bytes that is less than or equal to the target byte allocation, and to send a fourth set of data comprising the encoded version of the media data to the scheduler unit.

21. The system of claim 19, wherein the media encoder is further configured to send data representing one or more layers of encapsulation in which the media data has been encapsulated to the scheduler unit.

22. The system of claim 21, wherein the layers of encapsulation include one or more of ISO base media file format (BMFF) data, Real-Time Object Delivery over Unidirectional Transport (ROUTE) data, MPEG Media Transport (MMT) data, user datagram protocol (UDP), Internet protocol (IP), or ATSC 3.0 Link-layer Protocol (ALP).

23. The system of claim 19, further comprising a segmenter unit implemented in circuitry, the segmenter unit being configured to form the number of media segments from the encoded media data.

24. The system of claim 19, wherein the media encoder is further configured to send data representing a number of instantaneous decoder refresh (IDR) pictures corresponding to a playback time for the number of segments to the scheduler unit.

25. The system of claim 19, wherein the media encoder is further configured to send data representing whether an encoded version of the media data accompanies the estimated encoding bytes to the scheduler unit.

26. The system of claim 19, wherein the media encoder is configured to determine the first number of estimated encoding bytes during a first encoding pass.

27. The system of claim 19, wherein the media encoder is configured to send data representing a number of encoding passes to achieve a target byte allocation to the scheduler unit.

28. The system of claim 19, wherein the system comprises at least one of:
an integrated circuit;
a microprocessor; and
a wireless communication device.

29. A device for encoding and sending media data, the device comprising:
a scheduler unit that schedules transmission of media data, the scheduler unit implemented in circuitry;
a media encoder that encodes media data, the media encoder implemented in circuitry; and
a transmitter configured to transmit media data according to a schedule from the scheduler unit, the transmitter implemented in circuitry,
wherein the scheduler unit is configured to send a first set of data to the media encoder representing a number of media segments of the media data to be broadcast and a time at which the media data must be available for delivery at the transmitter of the media broadcast device;
wherein the media encoder is configured to send a second set of data representing a first number of estimated encoding bytes for the media data to the media encoder; and
wherein the scheduler unit is configured to send, to the transmitter, the number of media segments including respective portions of the encoded media data at or before the time at which the media data must be available for delivery at the transmitter.
